(19) United States
(12) Patent Application Publication
(10) Pub. No.: US 2006/0015493 A1
(43) Pub. Date: Jan. 19, 2006

(54) Enhanced records manager and related methods

(75) Inventor: Glen R. Walters, Hollywood, FL (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, ARMONK, NY (US)

(21) Appl. No.: 10/891,940

(22) Filed: Jul. 15, 2004

(51) Int. Cl. G06F 17/30

(52) U.S. Cl. 707/5

(57) ABSTRACT

A system for enabling an RMA for different system applications residing on the same computer system while avoiding enablement of the RMA for each of the system applications separately is provided. The system includes a monitoring module to monitor system application directories, a record generation module to generate an RMA-managed record based upon a system application file in a system application directory, and a substitution module that substitutes the RMA-managed record for the system application file. A computer-implemented method is also provided. The method includes monitoring at least one system application directory, generating an RMA-managed record based upon a system application file listed in the system application directory, and substituting the RMA-managed record for the system application file.

### FIELD OF THE INVENTION

The present invention relates to electronic files, and, more particularly, the automated management of such files

### BACKGROUND OF THE INVENTION

Businesses and governmental agencies have an ever increasing need for accurate and timely management of electronic files. Recent corporate scandals and legislation, such as the Sarbanes-Oxley Act, spawned by such scandals have only heightened the demand for automated management of electronic files. For example, the Securities and Exchange Commission (SEC) requires that select corporate documents be retained for a specified number of years. For a host of reasons, the loss of critical documents by a business or governmental agency can have grave legal or commercial consequences.

Yet, at the same time, it can be costly in terms of manpower and resource allocation to retain documents, even those stored in electronic form. Efficiency and economics, thus, dictate that businesses and governmental agencies manage their files so that the businesses and agencies are assured of having the files available as needed, but only for the duration that the files may be needed. Once such files are no longer relevant, they should be removed or destroyed.

A records managing application (RMAs) for electronic files, the IBM DB2 RECORDS MANAGER by International Business Machines Corporation of Armonk, N.Y., addresses these issues of electronic file management. Such an RMA is a software program that helps users file, store, retrieve, and manage the retention of their electronic records. These products work with a variety of common desktop applications such as e-mail software, digital imaging tools, electronic spreadsheet and presentation products, etc. RMAs have a variety of useful features, such as centralized filing and storage of electronic records, version control, robust search and retrieval, and automated disposition that is compliant with legal requirements.

The IBM DB2 RECORDS MANAGER RMA, for example, has a two-fold design incorporating a records manager (RM) and a records manager enabler (RME). File plans are defined and executed by the RM, while the RME serves as the end-user client portion of the design. The RME interfaces with various end-user applications and an electronic file repository such as the IBM DB2 CONTENT MANAGER also by International Business Machines Corporation.

Current RMA designs require that each end-user application capable of producing records be modified to interface with the RM. For example, enabling a particular application program on a system using the IBM DB2 RECORDS MANAGER can produce a dialog box having input fields for the content manager (CM) server name, RM server name, RM database name, user ID, and password. Similarly, selecting a “Declare Record” command produces another series of dialog boxes in which the user interacts with the RM in order to declare and classify the current word document as a record.

A problem that not been adequately addressed heretofore is the necessity of having to either enable each application separately or replace each application with one which is already enabled in order to accommodate current RMA designs. Accordingly, there is a need for a single application which can be installed on an end-user system that can handle all applications, even those lacking published interfaces.

### SUMMARY OF THE INVENTION

The invention is directed to a system and related methods for enabling an RMA for different system application residing on a computer system, and for accomplishing this enablement without having to enable the RMA for each of the system applications separately.

The system may include a monitoring module that monitors at least one system application directory. The system further may include a record generation module that generates an RMA-managed record based upon a system application file listed in a system application directory. Additionally, the system may include a substitution module that substitutes the RMA-managed record for the system application file.

A computer-implemented method according to the invention can include monitoring at least one system application directory. Moreover, the method can further include generating an RMA-managed record based upon a system application file listed in the system application directory. The method additionally can include substituting the RMA-managed record for the system application file.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram showing different system applications residing on a computer system and whose files are managed by an RMA enabled by a system according to one embodiment of the invention.

FIG. 2 is a schematic diagram of a system for enabling an RMA according to one embodiment of the invention.

FIG. 3 contains a flowchart illustrating the steps according to one embodiment of a method according to the invention.

### DETAILED DESCRIPTION OF PREFERRED EMBODIMENTS

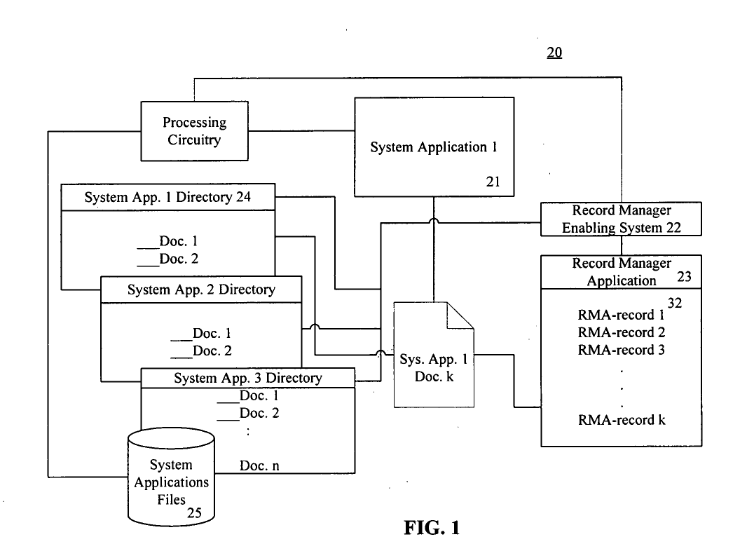

FIG. 1 provides a schematic diagram of a data processing device 20 on which resides at least one system application program 21 and a system 22 according to one embodiment of the invention. The data processing device 20 can be, for example, a general purpose computer, a workstation, or similar device known to those of ordinary skill in the art and having logic circuitry and related memory elements for storing data and logic instructions. The system 22 serves as an enabler for a record manager application (RMA) 23 for different system applications residing on the same data processing device 20 without having to enable the RMA for each of the system applications separately. The system 22 is illustratively integrated into the data processing device 20 that illustratively includes, among other components, memory 25 for storing one or more system application file directories 24.

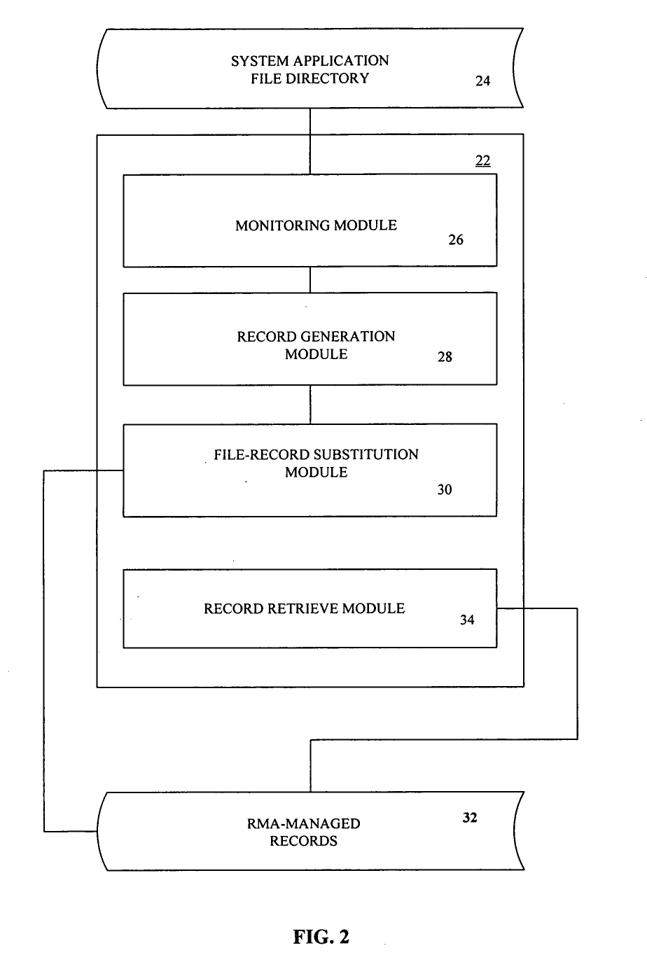

As further illustrated in FIG. 2, the system 22 includes a monitoring module 26 that monitors one or more system application file directories 24. The monitor 26 can implement various known monitoring techniques. The monitor 26 illustratively performs this monitoring task by polling the various system application file directories 24. As will be readily understood by those of ordinary skill in the art, however, the monitor 26 can be alternately configured to perform the monitoring task based upon a file system hook or other monitoring techniques known to those of ordinary skill in the art.

The system 22 as illustrated further includes a record generation module 28. The record generation module 28 generates an RMA-managed record, the RMA-managed record being based upon the particular system application file listed or contained in the system application directory 24. The record generation module 28 declares the system application file as a record and classifies the declared record as an RMA-managed record. The record generation module 28 writes system storing information identifying a memory location of the RMA-managed record within the computer system 20 and moves the RMA-managed record into memory 32 of the computer system 20. The record generation module 28 can respond to a command invoking a computer system 20 operation to store the system application file.

As illustrated, the system 22 additionally includes a substitution module 30. The substitution module 30 substitutes the RMA-managed record for the system application file by subsequently deleting or otherwise removing from the system application file directory 24 the system application file that was the basis for the RMA-managed record generated by the record generation module 28.

The system 22 as also illustrated further includes a retrieve module 34. The retrieve module 34 retrieves the saved and stored RMA-managed records in lieu of the system application files on which the RMA-managed records are based. The retrieve module 34 can respond to a system command invoking a system open operation, thus retrieving the RMA-managed record on the basis of the system storing information identifying its location in the memory. Accordingly, a system user wishing to retrieve the original system application file instead accesses the RMA-managed record upon which the former is based. Thus, the user need not sacrifice any of the options that obtain with ordinary file processing, yet is still able to gain the advantages features provided by the RMA. Moreover, this gain is achieved without the necessity of a separate enablement for each of the various system applications are configured to run on the computer system 20 and that may be the basis of a particular RMA-managed record.

In a particular scenario, according to one embodiment of the invention, the systems application is an electronic mail application (EMA) for sending and receiving electronic mail (e-mail) messages having, for example, mail server extensions. A typical e-mail system application is configured to create one or more special mail folders, into which an e-mail message ordinarily is moved. According to the invention, the monitoring module 26 monitors whether an e-mail message is to be stored in such a folder. If so, the record generation module 28 generates an RMA-managed record with the e-mail message as its content.

Accordingly, the system 22 generates an RMA-record in response to an EMA command invoking an operation to store an electronic mail message. The RMA-managed record so generated makes retention of the original e-mail message redundant. Therefore, the substitution module 30 can store the RMA-managed record in lieu of the original e-mail message and delete the latter. Again, though, if a system user wishes to access the content of the original e-mail message, the stored location information associated with the RMA-managed record is sufficiently for efficient and timely accessing of the RMA-managed record whose content is that of the original e-mail message.

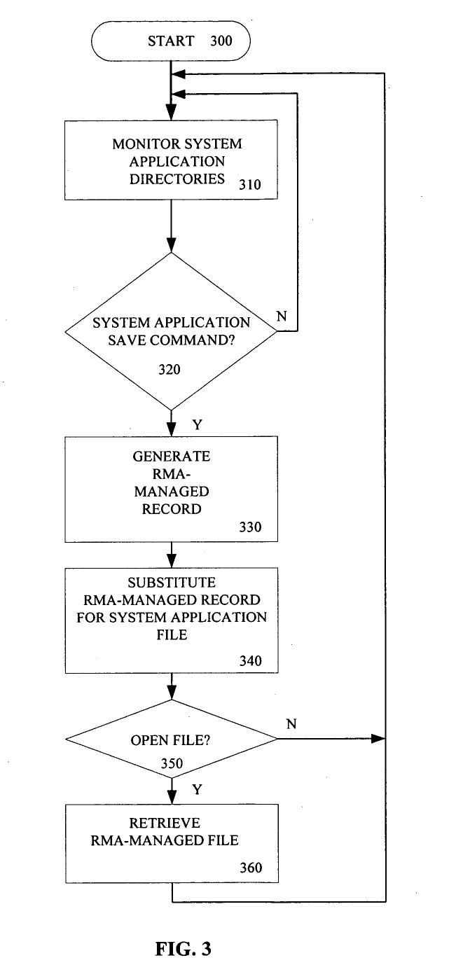

FIG. 3 is a flowchart showing one embodiment of a method according to the invention. The method provides for enabling a record manager application (RMA) with respect to several different computer system applications without the need for separate enablements of the RMA for each of the system applications individually. The method, according to the embodiment illustrated by the flowchart in FIG. 3, includes in step 310 monitoring system application directories, defining watch directories, that contain or list each file created by one of the system applications. As already noted, the step of monitoring can be performed by polling these various directories. Alternately, as will be readily understood by those of ordinary skill in the art, monitoring can be accomplished using a file system hook or other known monitoring technique.

When the monitoring of step 310 reveals that a system application file is to be saved, an RMA-managed record is generated in step 330 in response thereto. In particular, the system application file is illustratively declared as a record, and the record is classified according to the predetermined format of the RMA. The RMA-generated record, accordingly, contains the content of the system application file from which it is derived, but further includes identifying information that enables the record to be stored and managed by the RMA.

A command invoking a system operation to store the system application file, such as a save file command, can be the prompt that invokes the generating step 330. Thus, saving a document is all that is normally necessary according to the invention to create an RMA-managed record based on the saved document.

The generation of the RMA-managed record in step 330 comprises writing system storing information that identifies a memory location of the RMA-managed record. It follows, therefore, that retrieving a systems application file corresponds to retrieving the RMA-managed document based on that particular systems application file. Accordingly, a standard open file command is sufficient for opening the RMA-managed record: in response to the system command, the RMA-managed record is located on the bases of the system storing information.

The RMA-managed file is substituted for the original system application file in step 340, making retention of the systems application file on which it is based unnecessary. Accordingly, the substitution step 340 further can include deleting the application file from the computer system after the RMA-managed record has been generated in step 330.

The same method can be employed for managing electronic mail (e-mail) messages if the systems applications include an electronic mail application (EMA) for sending and receiving e-mail. Accordingly, an RMA-record can be generated in response to an EMA command invoking an operation to store an electronic mail. Specifically, a typical e-mail system application would create one or more special mail folders, into which an e-mail message would ordinarily be moved. According to the invention, moving the message to such a folder, results in the generation of an RMA-managed record with the e-mail message as its content.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

I claim:

1. A system for enabling a record manager application (RMA) for a plurality of system applications residing on a computer system while avoiding enablement of the RMA for each of the system applications separately, the system comprising:
a monitoring module monitoring at least one system application directory;
a record generation module generating an RMA-managed record based upon a system application file listed in the at least one system application directory; and
a substitution module substituting the RMA-managed record for the system application file.

2. The system of claim 1, wherein the record generation module declares the system application file as a record and classifies the declared record as an RMA-managed record.

3. The system of claim 1, wherein the record generation module operates in response to a command invoking a system operation to store the system application file.

4. The system of claim 1, wherein the record generation module writes system storing information identifying a memory location of the RMA-managed record.

5. The system of claim 4 further comprising a retrieve module opening the RMA-managed record in response to a system command invoking a system open operation, and based upon the system storing information.

6. The system of claim 1, wherein the substitution module deletes the application file from the computer system after the record generation module generates the RMA-managed record.

7. The system of claim 1, wherein the plurality of systems applications comprises at least one electronic mail application (EMA).

8. The system of claim 7, wherein the record generation module generates an RMA-record in response to an EMA command invoking an operation to store an electronic mail message.

9. A computer-implemented method of enabling a record manager application (RMA) for a plurality of system applications residing on a computer system while avoiding enablement of the RMA for each of the system applications separately, the method comprising:
monitoring at least one system application directory;
generating an RMA-managed record based upon a system application file listed in the at least one system application directory; and
substituting the RMA-managed record for the system application file.

10. The method of claim 9, wherein the step of generating comprises declaring the system application file as a record and classifying the declared record as an RMA-managed record.

11. The method of claim 9, wherein the step of generating commences in response to a command invoking a system operation to store the system application file.

12. The method of claim 9, wherein the step of generating comprises writing system storing information that identifies a memory location of the RMA-managed record.

13. The method of claim 12, further comprising opening the RMA-managed record in response to a system command invoking a system open operation, and based upon the system storing information.

14. The method of claim 9, wherein the step of substituting comprises deleting the application file from the computer system after generation of the RMA-managed record.

15. The method of claim 9, wherein the plurality of systems applications comprises at least one electronic mail application (EMA) for sending and receiving electronic mail (e-mail) messages.

16. The method of claim 15, wherein the step of generating comprises generating an RMA-record in response to an EMA command invoking an operation to store an electronic mail.

17. A computer readable storage medium for use in enabling a record manager application (RMA) for a plurality of system applications residing on a computer system while avoiding enablement of the RMA for each of the system applications separately, the storage medium comprising computer instructions for:
monitoring at least one system application directory;
generating an RMA-managed record based upon a system application file listed in the at least one system application directory; and
substituting the RMA-managed record for the system application file.

18. The computer readable storage medium of claim 17, wherein the computer instruction for generating comprises computer instructions to declare the system application file as a record and classify the declared record as an RMA-managed record.

19. The computer readable storage medium of claim 17, wherein the computer instruction for substituting comprises computer instructions to delete the application file from the computer system after generation of the RMA-managed record.

20. The computer readable storage medium of claim 17, wherein the plurality of systems applications comprises at least one electronic mail application (EMA) for sending and receiving electronic mail (e-mail) messages, and wherein the computer instruction for generating comprises generating an RMA-record in response to an EMA command invoking an operation to store an electronic mail.
